(19) United States
(12) Patent Application Publication
(10) Pub. No.: US 2024/0190356 A1
(43) Pub. Date: Jun. 13, 2024

(54) BICYCLE RACK

(71) Applicant: Jeff A. Wilson, Lakewood, CO (US)

(72) Inventor: Jeff A. Wilson, Lakewood, CO (US)

(21) Appl. No.: 18/491,986

(22) Filed: Oct. 23, 2023

Related U.S. Application Data
(60) Provisional application No. 63/386,510, filed on Dec. 8, 2022.
(60) Provisional application No. 63/480,569, filed on Jan. 19, 2023.
(60) Provisional application No. 63/489,433, filed on Mar. 10, 2023.

(51) Int. Cl. B60R 9/10

(52) U.S. Cl. CPC B60R 9/10

(57) ABSTRACT

An example bicycle rack has a base for securely anchoring to a truck bed, a frame stabilizer connected to the base, and a wheel mounting assembly for receiving the two wheels of the bicycle so that the bicycle sits substantially above the truck bed rail. Another example bicycle rack has down-legs for mounting to the floor of the truck bed. Another example bicycle rack has a base for securely attaching to a hitch receiver of a truck or other vehicle, a wheel mounting assembly for receiving the two wheels of the bicycle, and at least one wheel stabilizer connected to the base.

### PRIORITY CLAIM

This application claims the priority filing benefit of U.S. Provisional Patent Application No. 63/386,510 filed Dec. 8, 2022 for “Truck Bed Bicycle Rack” of Jeff A. Wilson, U.S. Provisional Patent Application No. 63/480,569 filed Jan. 19, 2023 for “Truck Bed Bicycle Rack” of Jeff A. Wilson, and U.S. Provisional Patent Application No. 63/489,433 filed Mar. 10, 2023 for “Bicycle Rack” of Jeff A. Wilson, each hereby incorporated by reference in its entirety as though fully set forth herein.

### BACKGROUND

Cycling continues to gain in popularity. Often, cyclers need to get their bicycle to a bike path or trailhead, and this is often by driving their truck or car with the bicycle on a rack attached to the vehicle. There are numerous racks and rack attachments available to transport bicycles on vehicles. For example, racks can be installed on the roof or trunk of a car. Pickup truck owners often just toss their bicycles in the truck bed for transport. But this can result in damage (e.g., at least scratching) to the bicycle and/or the truck bed. Hanging the front wheel over the tailgate of the pickup truck is also an option for many. But this too can cause damage to the bicycle and/or the truck bed.

### BRIEF DESCRIPTION OF THE DRAWINGS

FIGS. 1-3 show an example bicycle rack as it may be mounted on top of the side rail of a pickup truck bed to carry a bicycle on the side rail.

FIGS. 4-6 show another example bicycle rack as it may be mounted to the truck bed floor adjacent to the side of the bed of a pickup truck to carry a bicycle up out of the bed along the side rail.

FIGS. 7A and 7B show another example bicycle rack as it may be mounted to the truck bed floor along a side rail of a pickup truck bed to carry a bicycle at least partly down inside the truck bed along the side rail, both (A) without a bicycle, and (B) with a bicycle.

FIGS. 8A and 8B shows an example bicycle rack as it may be mounted to a hitch receiver of a pickup truck bed to carry a bicycle behind the truck, both (A) without a bicycle, and (B) with a bicycle.

FIG. 9 shows the example bicycle rack of FIGS. 8A and 8B as it may be mounted to a hitch receiver of a pickup truck bed to carry a bicycle behind the truck.

FIGS. 10-11 show an example of one of the wedge tire stops on the base of the bicycle rack for securing a tire of the bicycle.

FIGS. 12-13 show an example of one of the wedge tire stops on the wheel stabilizers for securing a tire of the bicycle.

FIG. 14 shows the example of one of the wedge tire stop of FIG. 13 with a bicycle tire.

### DETAILED DESCRIPTION

A bicycle rack is disclosed including embodiments for mounting to a truck bed (on and along the side rail, as well as at least partly inside the truck bed), and for mounting to a hitch receiver of a truck or other vehicle. The example bicycle rack embodiments can be made of welded steel, although other materials (e.g., aluminum, carbon fiber) and other types of connections (e.g., screws/bolts) may be provided. In an example, the bicycle rack may include adjustable components (e.g., sliding tire trays, down-leg mounts, and adjustable wedges for securing the tires of the bicycle) to accommodate different size bicycles.

In one embodiment, the bicycle rack is mounted to a side rail of the truck bed, and a bicycle is mounted to the bicycle rack, thus mounting the bicycle to the truck bed. In this example, the frame of the bicycle rack includes a base that is securely anchored to the side rail of the truck bed, a frame stabilizer connected to the base, and a wheel mounting assembly for the bicycle wheels. During use, the bicycle wheels are positioned in the wheel mounting assembly, and the bicycle frame is connected to the frame stabilizer. The bicycle is thus mounted on the truck bed rail and sits substantially above the top of the truck bed rail. The frame stabilizer reduces or altogether eliminates sway of the bicycle during transport. The frame stabilizer absorbs most, if not all of the sway or travel energy. The truck bed is completely unobstructed for hauling and line of sight, both of the driver and other vehicles on the road.

In another embodiment, the bicycle rack includes a frame stabilizer with an artistic element. Also in this embodiment, the bicycle rack is mounted to the floor of the truck bed. It is noted that combinations of these are also contemplated. For example, the bicycle rack that is mounted to the side rail of the truck may have an artistic element and/or the bicycle rack that does not have an artistic element may include down-legs to mount the bicycle rack to the floor of the truck bed.

In another embodiment, the bicycle rack is mounted to the floor of the truck bed, but with the base at or about level with the wheel well of the truck. In this example, the bicycle sits at least partly down inside the truck bed.

In another embodiment, the bicycle rack is mounted to a hitch receiver, and the bicycle is mounted to the bicycle rack, thus mounting the bicycle rack to the back of the truck (outside of the truck bed). In this example, the frame of the example bicycle rack includes a base that is securely anchored to the truck hitch, and a wheel mounting assembly for the bicycle wheels. During use, the bicycle wheels are positioned in the wheel mounting assembly. Optional wheel stabilizers may be rotated over the front and/or rear wheels of the bicycle. Tire wedges in the base and/or on the wheel stabilizers help to reduce or altogether eliminate sway and fore/aft movement of the bicycle during transport.

These example bicycle racks are each designed to safely transport bicycles in a truck or other vehicle equipped with a suitable mounting location for the bicycle rack.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

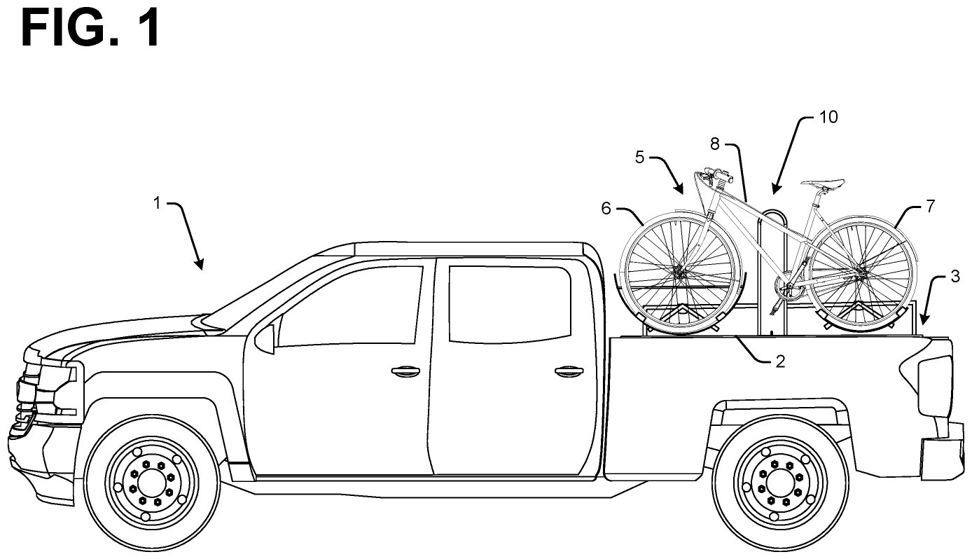

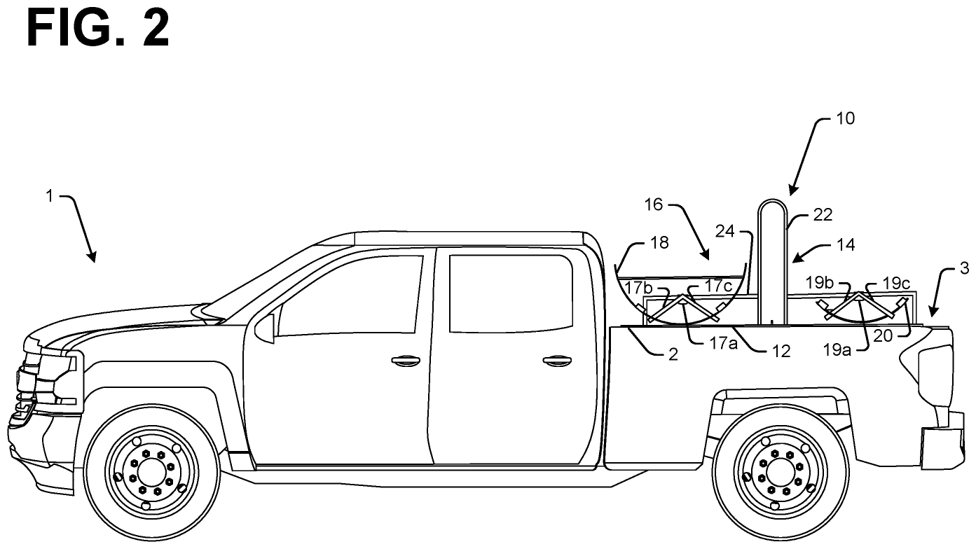

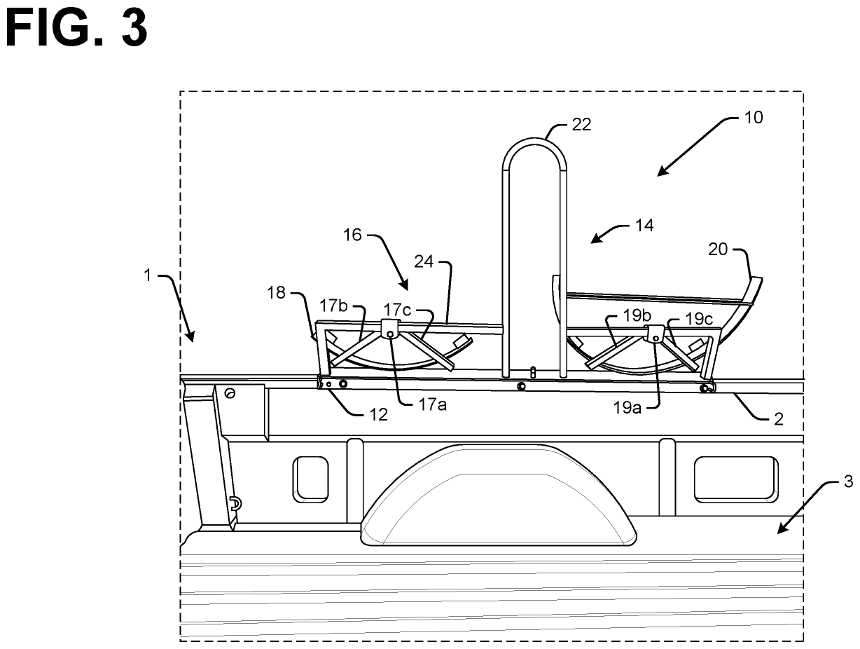

FIGS. 1-3 show an example bicycle rack 10 as it may be mounted to the side rail 2 of a bed 3 of a pickup truck 1 to carry a bicycle 5 on the side rail 2. An example of the bicycle rack 10 includes a base member (or base) 12 that can be securely anchored to a side rail 2 of a truck bed 3, a frame stabilizer 14 connected to the base 12, and a wheel mounting assembly 16 having a front wheel mount 18 and a rear wheel mount 20 for receiving the two wheels 6 and 7 of the bicycle 5.

In an example, the base 12 has a substantially L-shaped side profile with a top plate for positioning on top of the side rail 2, and a lip for positioning along the inside of the truck bed 3 on the side rail 2. The shape thus supports against side-to-side movement of the bicycle rack 10. The base 12 can be bolted or otherwise secured to the side rail 2 of the bed 3 of the truck 1. The bicycle rack 10 can be mounted to either side of the truck bed. In an example, separate racks (not shown) can be mounted to both side rails 2 of the bed 3 of the truck 1. In another example, the bicycle rack 10 can be expanded (e.g., made wider) to accommodate multiple bicycles and/or other equipment and/or accessories.

The frame stabilizer (or stabilizer) 14 of the bicycle rack 10 includes a vertically extending, generally U-shaped support member 22. The stabilizer also includes a horizontally extending support member 24. The wheel mounting assembly 16 may be at least partly mounted to the stabilizer 14 (e.g., the vertical support member 22 and/or horizontal support member 24), and/or to the base 12. As such, the stabilizer 14 reduces or altogether eliminates sway of the bicycle 5 during transport.

In an example, the wheel mounting assembly 16 has both a front wheel tray 18 and a rear wheel tray 20. In an example, the wheel trays may be semi-circular to correspond to the shape of the bicycle wheels 6 and 7. Other shapes are also contemplated as being within the scope of this disclosure. Also in an example, the front wheel tray 18 may be larger (e.g., taller) than the rear wheel tray 20. Such a configuration helps hold the front wheel 6 of the bicycle 5 in an upright fixed position while the user is mounting the bicycle 5 onto the bicycle rack 10. That is, the user may first position the front wheel 6 of the bicycle 5 in the wheel mounting assembly 16, and then, with the front wheel held in place by the front wheel tray 18, swing the bicycle 5 over the bicycle rack 10. Again, other sizes of the wheel trays 18 and 20 are also contemplated as being within the scope of this disclosure.

In an example, one or both of the front wheel tray 18 and the rear wheel 20 tray may be slidably mounted to the base 12 (e.g., at connection 17a) and/or to the horizontal support member 24 (e.g., via cross braces 17b and 17c). This enables the user to adjust the distance between the front wheel tray 18 to accommodate different bicycle sizes. In another example, the rear wheel tray 20 is also slidably mounted to the base 12 (e.g., at connection 19a) and/or to the horizontal support member 24 (e.g., via cross braces 19b and 19c). In another example, the rear wheel tray 20 is fixedly mounted (so that it is not adjustable) to the base 12). In an example, one of the wheel trays is shorter in length than the other wheel tray to help reduce or altogether eliminate fore and aft movement, and to accommodate different sizes of bicycles.

During use, the user can position the two wheels 6 and 7 of the bicycle 5 in the wheel mounting assembly 16 so that the bicycle 5 stands upright on the bicycle rack 10. In an example, the user may first position the front wheel 6 of the bicycle 5 in the wheel mounting assembly 16, and then swing the bicycle 5 over the bicycle rack 10 so that the rear wheel 7 is positioned in the wheel mounting assembly 16. The user can use both hands to secure the bicycle 5 to the bicycle rack 10 for transport. The frame 8 of the bicycle 5 can then be connected to the stabilizer 14 of the bicycle rack 10 (e.g., with straps) to securely mount the bicycle 5 along the side rail 2 of the bed 3 of the truck 1. Once secured, the bicycle 5 sits substantially above the side rail 2 of the bed 3 of the truck, out of the way of the driver's view out the back window of the truck 1, and without taking up cargo space within the bed 3 of the truck 1.

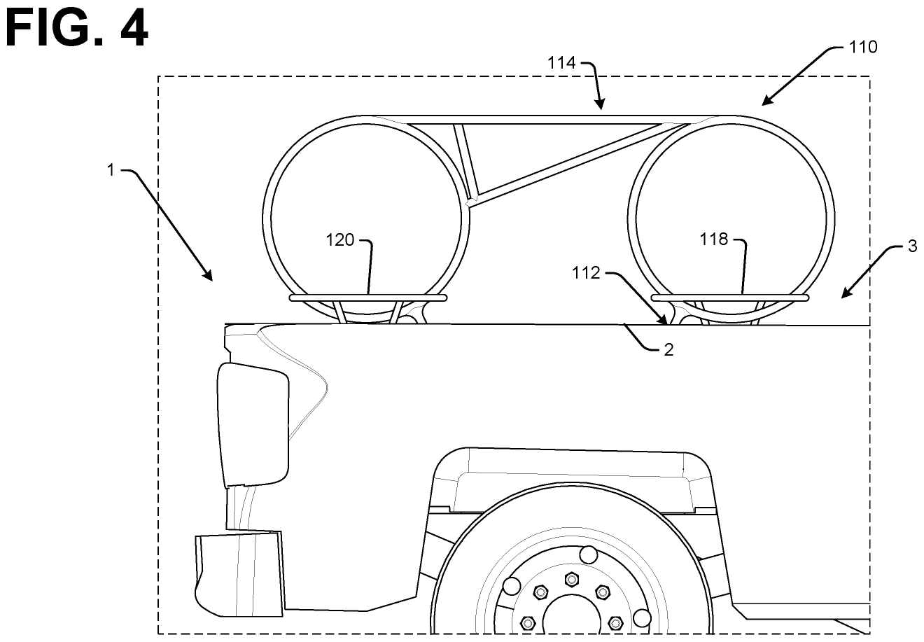

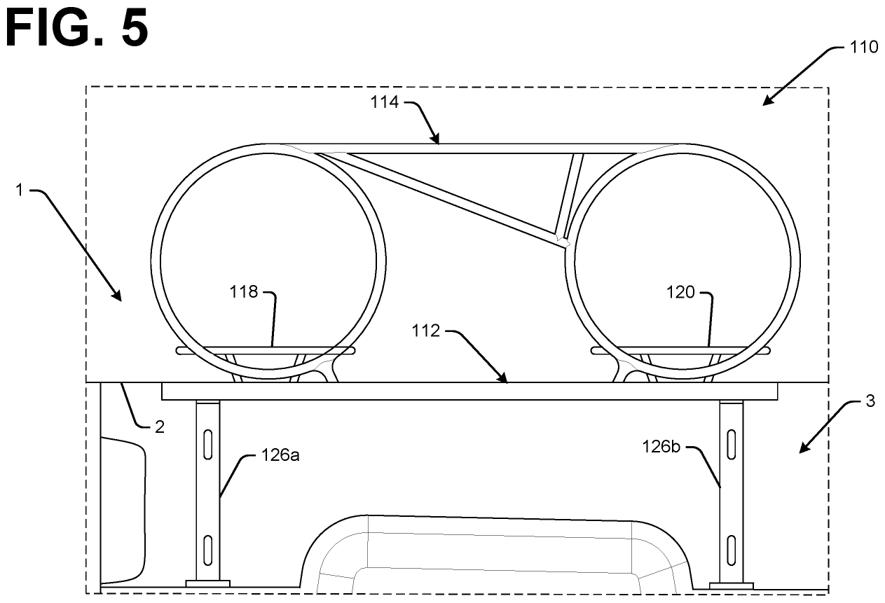

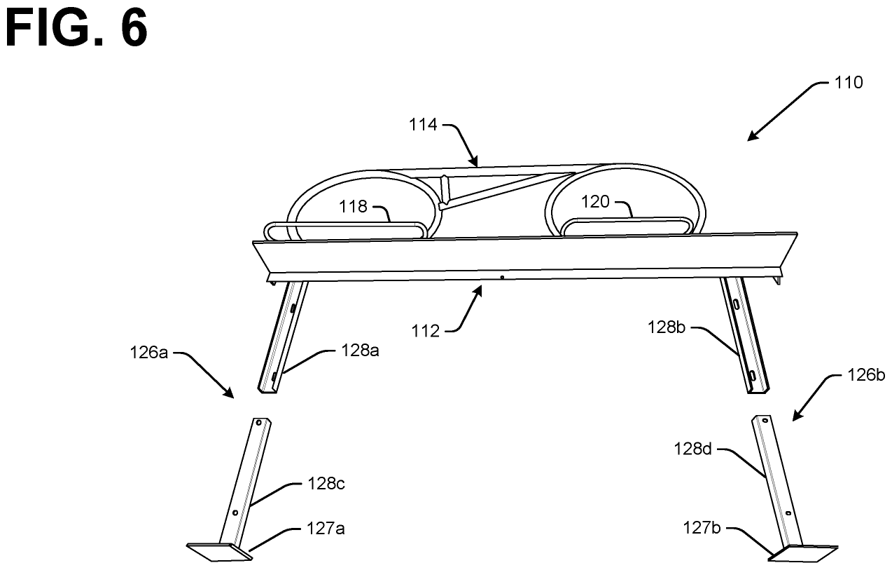

FIGS. 4-6 show another example bicycle rack 110 having a stabilizer 114 with an artistic design element. It is noted that 100-series reference numbers are used in FIGS. 4-6 to correspond to like components already described above with reference to FIGS. 1-3.

The bicycle 5 is carried in substantially the same position as that shown in FIG. 1 for bicycle rack 110, alongside the side rail 2 and up out of the bed 3 of the truck. In the example shown, the bicycle rack 110 is sized to accommodate a single bicycle. In another example, the bicycle rack 110 can be expanded (e.g., with wheel trays 118 and 120 on each side of the stabilizer 114) to accommodate multiple bicycles and/or other equipment.

The stabilizer 114 of the example bicycle rack 110 has an artistic design element, referred to herein as the “Art” or “Art Frame”. In an example, the stabilizer 114 is a silhouette of a bicycle (hence the “Art”). The “Art” is a form of communication. People who favor a sport want to express themselves to connect with like-minded people (e.g., other bicyclists). In addition, the “Art” adds some ‘swagger’ to the pickup truck. Other forms of the “Art” may include silhouettes of mountains, trees, bears (or other animals) and/or other art forms.

In an example, the bicycle rack is made of tubular components, to further enhance the artistic element. All of the components, including the stabilizer 114 and wheel trays 118 and 120, may be formed with matching tubular steel (or other suitable materials).

The stabilizer 114 is configured with wheel openings having sufficient space for the bicycle axles. Additional space is provided between the wheel silhouettes to provide space for the sprocket and pedals of the bicycle 5.

The tire trays of the example truck bed bicycle rack shown in these figures may be smaller, so as to not interrupt the lines of the “Art.” The front tire tray 118 is smaller than the rear tire tray 120. This helps to reduce or altogether eliminate fore and aft movement of the bicycle by better fitting the front wheel. The rear tire tray 120 is longer to accommodate different sizes of bicycles.

It is noted that older trucks have side rails made with double wall construction. This older design better supports the bicycle rack 10 mounted to the side wall 2 of the bed 3 of the truck 1. Many newer trucks are now made with single wall side rails that may not support the bicycle rack 10 mounted to the side wall 2 of the bed 3 of the truck 1. Accordingly, the base 112 of the bicycle rack 100 is shown as it may be mounted to the floor of the truck 3. In an example, the bicycle rack 110 includes at least one down-leg 126a-b on the base 112. the down-leg(s) 126a-b may be positioned inside and mounted (e.g., via bolting platform 127a-b) to the floor of the truck bed 3. The base 120 of the bicycle rack 110 may also be mounted to the side rail 2, e.g., for additional stability. It is noted that either bicycle rack (10 and 110) may include down-legs 126a-b to provide additional support for mounting to the bed 3 of the truck 1.

In an example, the down-leg(s) 126a-b may be adjustable in height, e.g., to accommodate different depth truck beds. In an example, the down-leg(s) 126a-b may include separate members 128a-d with multiple openings and/or slotted channels to accept a nut and bolt that can be tightened at various positions to adjust the height of the down-legs 126a-b.

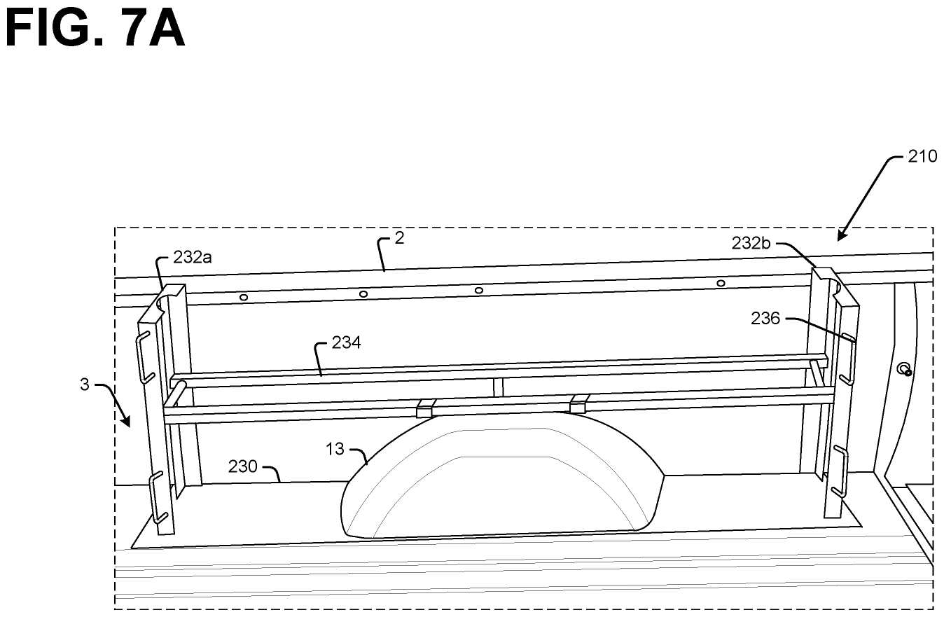

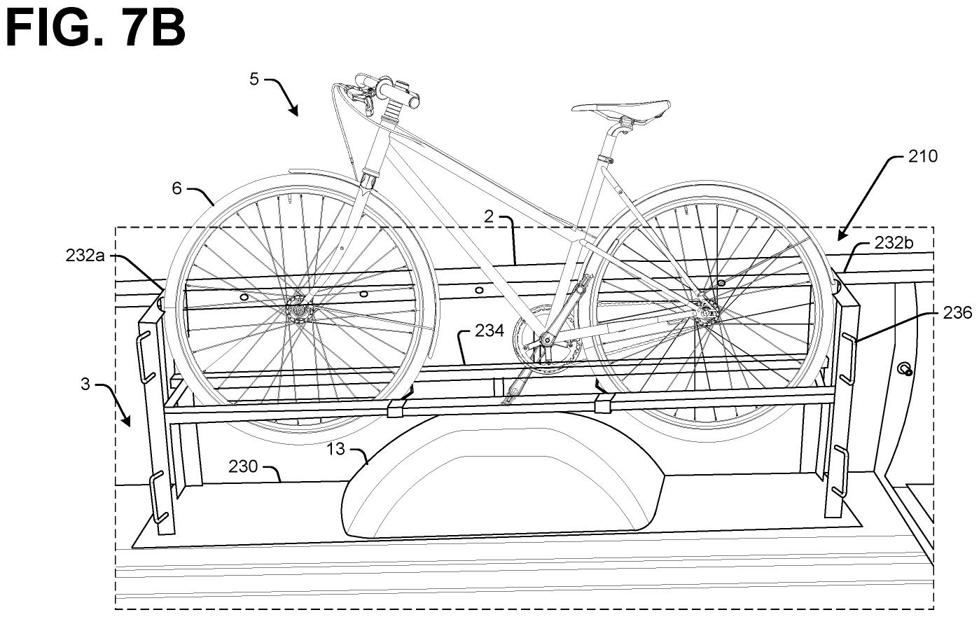

FIGS. 7A and 7B show another example bicycle rack 210 as it may be mounted to the truck bed floor along a side rail of a pickup truck bed to carry a bicycle at least partly down inside the truck bed along the side rail, both (A) without a bicycle, and (B) with a bicycle 5. It is noted that 200-series reference numbers are used in FIGS. 7A and 7B to correspond to like components already described above with reference to FIGS. 1-3 and FIGS. 4-6.

The bicycle rack 210 may be mounted to the floor of the truck bed 3 along a side rail 2 of a truck to carry a bicycle 5 at least partially inside of the truck bed 3. In the example shown, the bicycle rack 210 is sized to accommodate a single bicycle. In another example, the bicycle rack 210 can be expanded to accommodate multiple bicycles and/or other equipment.

The example bicycle rack 210 is provided on a floor plate 230 that rest on (e.g., to avoid drilling into the floor of the truck bed 3) or may be bolted to the floor of the truck bed 3.

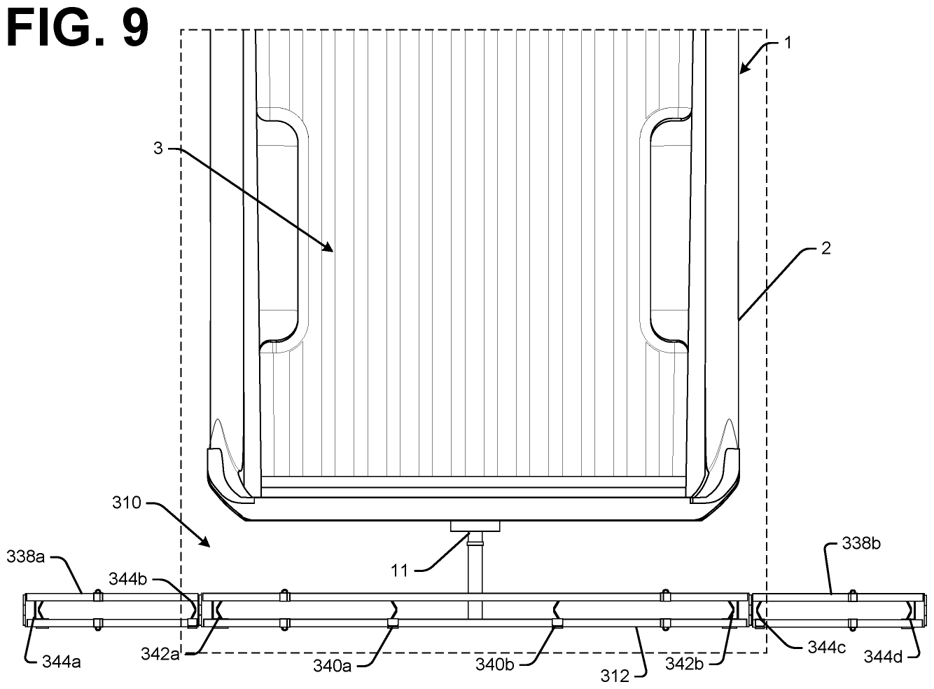

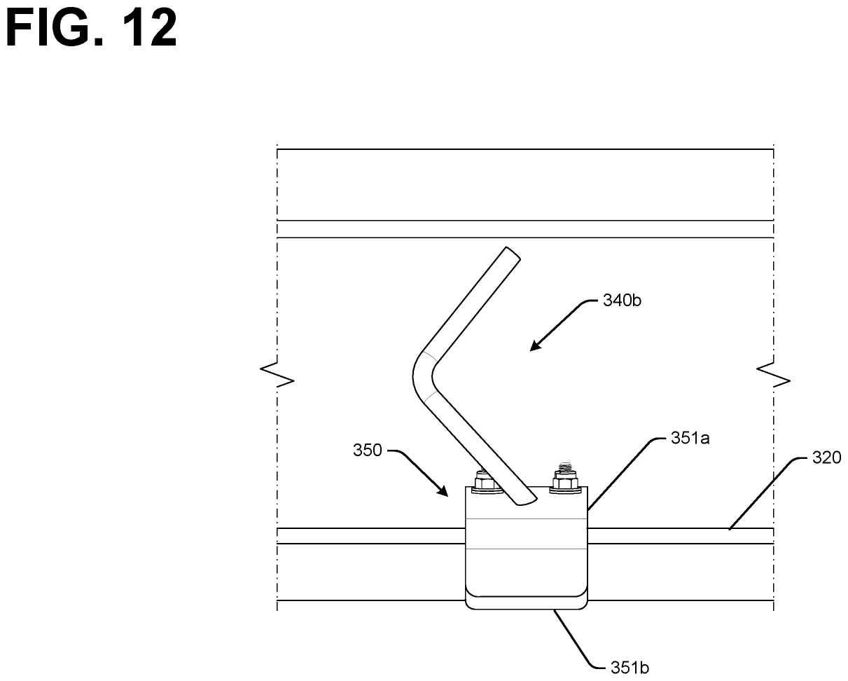

The bicycle rack 210 includes a frame assembly having vertical members 232a-b and cross member 234 having wheel slots or channels formed therein. In an example, the cross member 234 is positioned just above the wheel well 13, and the wheels 6 and 7 of the bicycle 5 fit into the slots in cross member 234. More than one wheel channel or slot may be formed in the cross member to accommodate additional bicycles. The vertical members 232a-b may be a fixed height, or made adjustable to accommodate different depths of truck beds and/or wheel well sizes. The bicycle 5 may be strapped (e.g., to handles 236 or other connection points and/or to the truck bed 3). Optional wheel channel dividers (not shown in FIGS. 7A and 7B) may be provided to secure the wheels 6 and 7 of the bicycle 5 (see, e.g., FIGS. 9 and 12).

It can be seen in FIG. 7B how the wheels 6 of the bicycle 7 drop below and/or into the two-rail platform, thereby lessening overhead sway of the bicycle 7 which could otherwise potentially damage the bicycle 5 and/or the bed 3 of the truck 1.

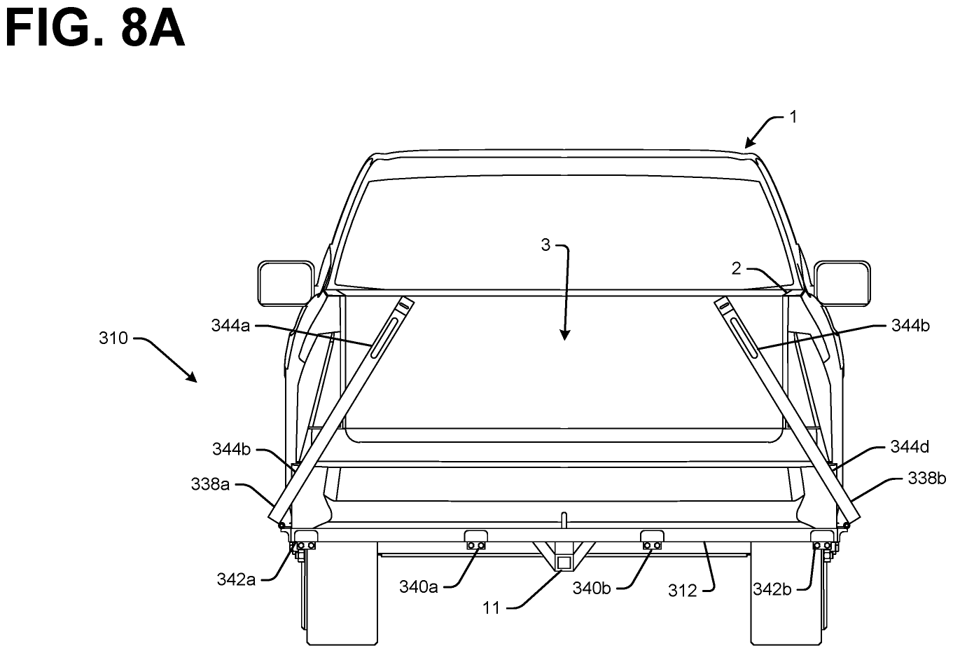

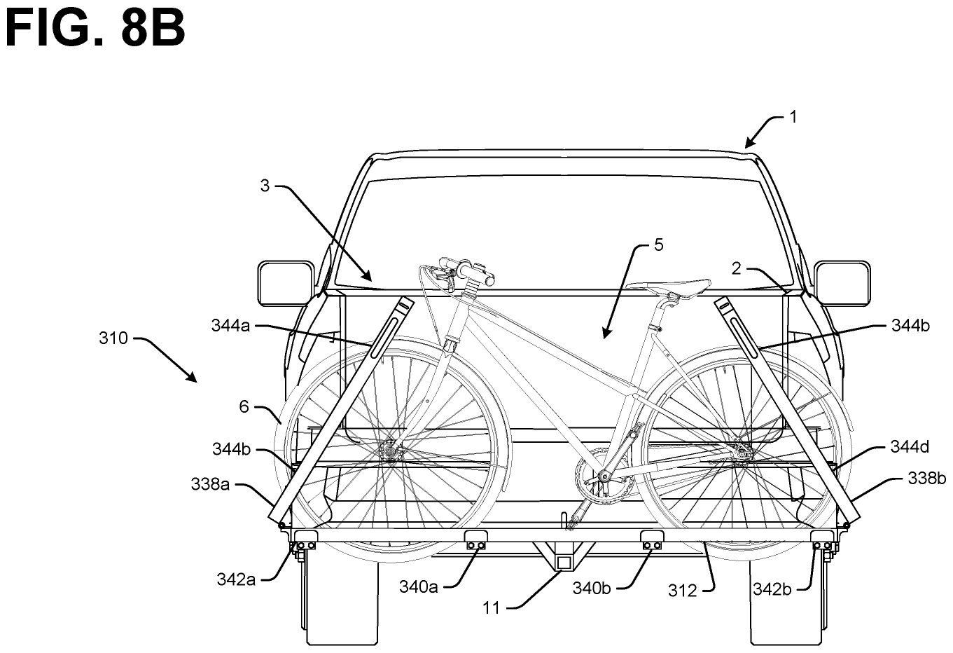

FIGS. 8A and 8B shows an example bicycle rack 310 as it may be mounted to a hitch receiver 11 of a pickup truck to carry a bicycle 5 behind the truck 1, both (A) without a bicycle, and (B) with a bicycle 5. FIG. 9 shows the example bicycle rack 310 of FIGS. 8A and 8B as it may be mounted to a hitch receiver 11 of a pickup truck 1 to carry a bicycle 5 behind the bed 3 of the truck 1. It is noted that 300-series reference numbers are used in FIGS. 8-9 to correspond to like components already described above with reference to FIGS. 1-3, FIGS. 4-6, and FIGS. 7A and 7B.

The bicycle rack 310 may be mounted to a hitch receiver 11 of a truck 1 or other vehicle to carry a bicycle 5 behind the bed 3 of the truck 1 or other vehicle. The example bicycle rack 310 can be bolted or otherwise secured (e.g., via pin) to the receiver hitch of a truck or other vehicle equipped with a suitable mounting system.

The bicycle 5 may be secured to the bicycle rack 310 with optional straps and/or other connections to reduce or altogether eliminate sway. In the example shown, the hitch-mounted bicycle rack 310 accommodates a single bicycle. The installed bicycle 5 sits on the base 312 with the wheels 6 and 7 partly down into the channel formed in the base 312 (similar to the embodiment of FIGS. 7A and 7B). The bicycle rack 310 may carry a single bicycle, or be widened to accommodate multiple bicycles and/or other equipment.

This example of the bicycle rack 310 includes a base 312 for securely attaching to a hitch receiver of a truck or other vehicle. The base 312 is formed with a wheel mounting assembly 316 including at least one channel for receiving the wheels 6 and 7 of the bicycle 1. At least one wheel stabilizer 338a-b is connected to the base 312. The wheel stabilizers 338a-b reduce or altogether eliminate sway of the bicycle 1 during transport.

In an example, the wheel mounting assembly 316 has a front wheel slot 318 and a rear wheel slot 320. The wheel slots 318, 320 may be formed within a single channel, or formed as separate channels in the base 312. In an example, wedges 340a, 340b may form the front wheel slot 316 and the rear wheel slot 318. The wedges 340a, 340b may be mounted on the base 312 to slide to different positions within the base 312 to accommodate different size tires (and thus different bicycle sizes).

In an example, the front wheel slot 318 may be made shorter than the rear wheel slot 320 to help reduce or altogether eliminate fore and aft movement of the bicycle. The rear tire slot 320 may be longer to accommodate different sizes of bicycles and/or tire size. In another example, one or both of the tire slots 318, 320 may be adjustable to accommodate different size bicycle tires, e.g., to include larger e-bicycles and motorized dirt bikes.

An example of the bicycle rack includes a base having at least one slot for receiving the two wheels of the bicycle. A size adjustable wheel mounting assembly 316 of the base 320 has a first front wedge tire stop 342a and a first rear wedge tire stop 340a for receiving the front wheel 6 of the bicycle 1. The wheel mounting assembly 316 also has a second front wedge tire stop 340b and a second rear wedge tire stop 342b for receiving the rear wheel 7 of the bicycle 1. The wedge tire stops serve to better secure the wheels of the bicycle 1 against horizontal movement.

In an example, the wheel stabilizer 338a includes a front wheel arm 338a rotatable between an open position (shown in FIG. 9) for mounting the bicycle 1 on the bicycle rack 310. The front wheel arm 338a is also rotatable to a closed position (shown in FIGS. 8A and 8B) for securing the front wheel 6 of the bicycle 1. In an example, there is both a front wheel arm 338a and a rear wheel arm 338b. The rear wheel arm 338b is rotatable between an open position (shown in FIG. 9) for mounting the rear tire 7 of the bicycle 1. The rear wheel arm 338b is also rotatable to a closed position (shown in FIGS. 8A and 8B) for securing the rear wheel 7 of the bicycle 1. The front wheel arm 338a and the rear wheel arm 338b have slots that fit at least partially around the front wheel 6 and the rear wheel 7 of the bicycle 1 to hold the bicycle 1 in an upright position.

In an example, the front wheel arm 338a and the rear wheel arm 338b each have wedge tire stops (e.g., upper and lower tire stops) at positions 344a-d shown in FIGS. 8 and 9. The wedge tire stops serve to better secure the wheels of the bicycle 1 against vertical movement.

In an example, there are four wedge tire stops (or tire hugger brackets) on each tire (four on the front tire 6, and four on the rear tire 7) to absorb the energy generated by the vehicle travel.

It can be seen in FIG. 8B how the wheels 6 of the bicycle 7 drop below and/or into the two-rail platform, thereby lessening overhead sway of the bicycle 7 which could otherwise potentially damage the bicycle 5 and/or the bed 3 of the truck 1.

The bicycle 1 is secured both the front and rear tires 6 and 7 to eliminate any physical damage or paint damage to the bicycle and/or vehicle. In an example, all of the wedge tire stops may be moveable. In another example, one or more of the opposing wedge tire stops may be fixedly mounted to the base, and only the other of the opposing wedge tire stops is adjustable.

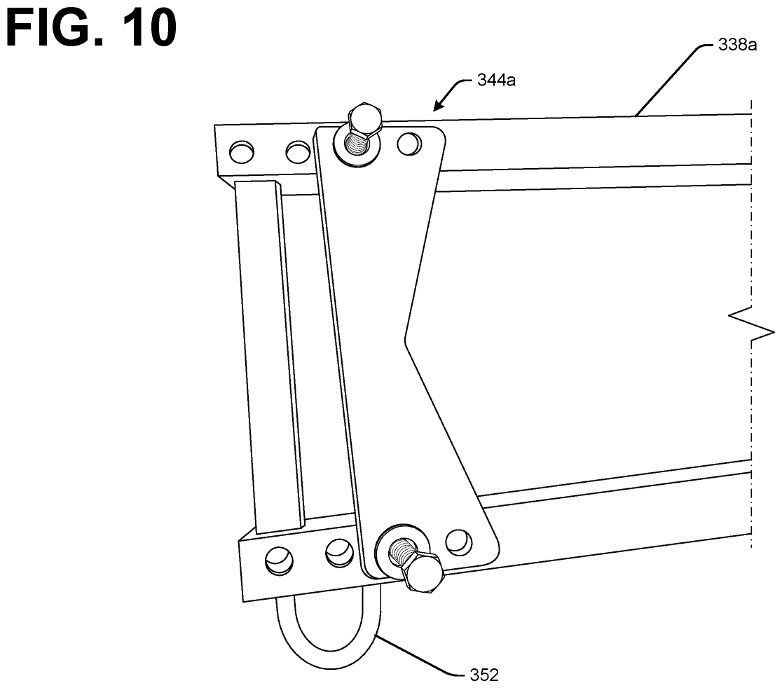

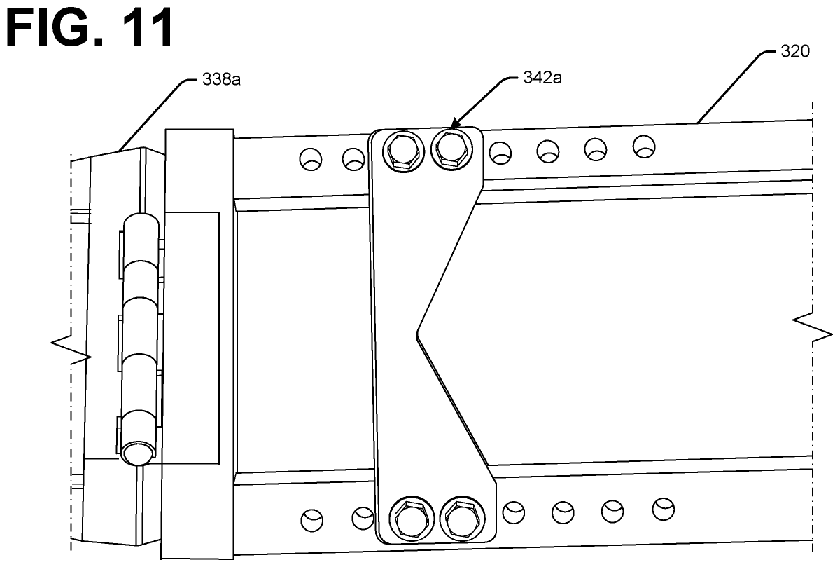

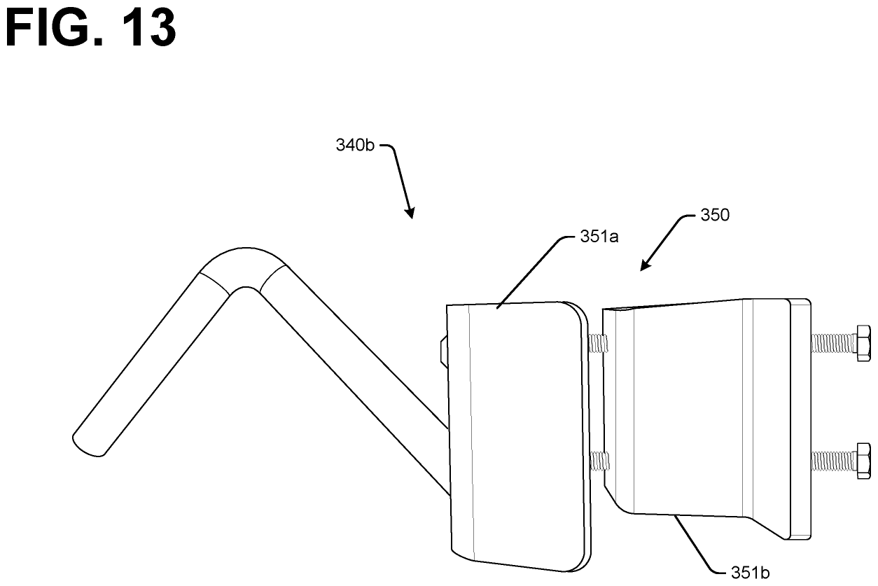

Examples of the wedge tire stops are shown in FIGS. 10-11 and 12-13. Although the embodiment shown in FIGS. 10-11 are shown as wedge tire stops 342a and 342b, and the embodiment shown in FIGS. 12-13 are shown as wedge tire stops 340a and 340b, it is noted that any of these embodiments may be provided as wedge tire stops in any position in the base 320. Likewise, any of the wedge tire stops 340a-b and 342a-b may be provided on the front wheel arm 338a and the rear wheel arm 338b. In addition, other embodiments (not shown) of the wedge tire stops may also be provided, as will be readily understood by those having ordinary skill in the art after becoming familiar with the teachings herein.

The front wheel slot and the rear wheel slot may have opposing wedge tire stops. FIGS. 10-11 show an example of wedge tire stops (e.g., 340a, 342a, and 344a-d in FIG. 9) which may be provided on the bicycle rack 310 for receiving a tire of the bicycle 1 therebetween. In this example, the wedge tire stops may be secured on both sides. The wedge tire stops may be generally V-shaped to better fit at least partly around the bicycle tires. In addition, various connection points (e.g., loop 352) may be provided at various places on any of the bicycle rack embodiments for attaching straps to help secure the bicycle 5.

The wedge tire stops 340a, 342a, and 344a-d receive the tire of the bicycle therebetween to limit sway of the bicycle 1 all three planes in the x-y-z coordinate system. The wedges can be tightened in place, and/or loosened for adjustment (e.g., to accommodate larger or smaller tires, and/or so that the bicycle can sit down lower or up higher in the rack).

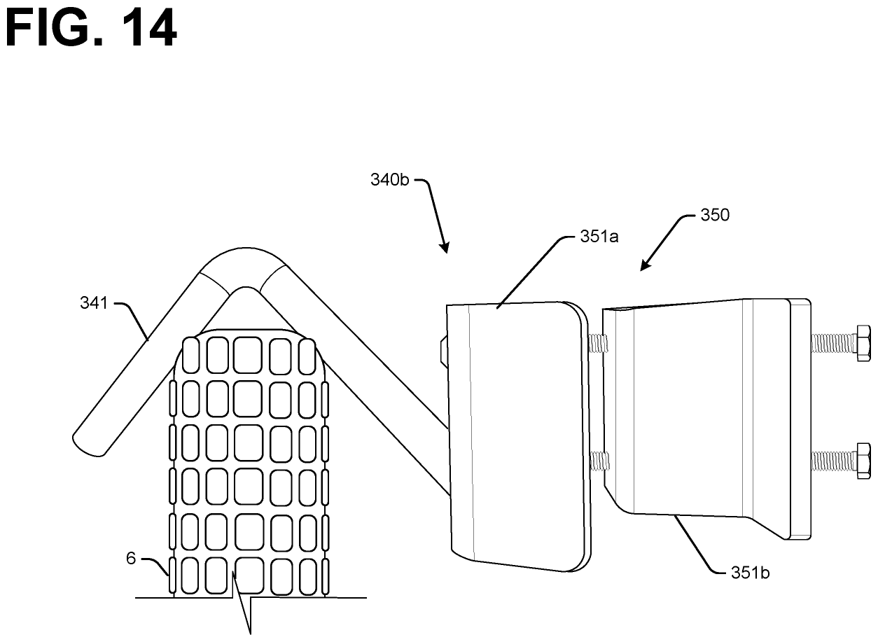

FIGS. 12-13 show an example of wedge tire stops (e.g., 340b and 342b in FIG. 9) which may be provided on the bicycle rack 310 for receiving a tire of the bicycle 1 therebetween. FIG. 14 shows the example of one of the wedge tire stops of FIG. 13 with a bicycle tire 6. In this example, the wedge tire stops may be secured on only one side. The wedge tire stop may be mounted via bracket assembly 350 having mating L-shaped brackets 351a, 351b that clamp that is bolted together around the square tube portion of base 320 and/or members 338a, 338b. Loosening the bolts enables the brackets to slide along the tubing for adjustment. It is noted that the tubing of base 320 and/or members 338a, 338b need not be square, and thus the brackets 351, 351b may be sized and shaped to work with any size and/or shape tubing.

The wedge tire stops are hook-shaped (or generally V-shaped) to better fit at least partly around the bicycle tires. The wedge tire stops 340a, 342a, and 344a-d receive the tire of the bicycle therebetween to limit sway of the bicycle 1 all three planes in the x-y-z coordinate system. The wedges can be tightened in place, and/or loosened for adjustment (e.g., to accommodate larger or smaller tires, and/or so that the bicycle can sit down lower or up higher in the rack).

The tire wedges into the bracket, thereby hugging 3 sides of the bicycle tire 6. The deep V bracket is shown as it may secure 1″ wide to 4″ wide tires and/or secure a race bicycle 5 to a fat tire bicycle. Four brackets on each tire hold the bicycle 5 upright without touching any painted surface.

It is noted that the examples shown and described are provided for purposes of illustration and are not intended to be limiting. Still other examples are also contemplated.

1. A bicycle rack for a bicycle having two wheels and a bicycle frame, comprising:
a base for securely anchoring to a truck bed;
a frame stabilizer connected to the base; and
a wheel mounting assembly for receiving the two wheels of the bicycle;
wherein the two wheels of the bicycle are positioned in the wheel mounting assembly, and a bicycle frame is connected to the frame stabilizer of the bicycle rack to mount the bicycle along an inside rail of the truck bed so that the bicycle sits substantially above the truck bed rail;
wherein the frame stabilizer reduces or altogether eliminates sway of the bicycle during transport.

2. The bicycle rack of claim 1, wherein the stabilizer further comprises a vertically extending, generally U-shaped support member.

3. The bicycle rack of claim 1, wherein the stabilizer further comprises a horizontally extending support member.

4. The bicycle rack of claim 1, wherein the wheel mounting assembly has a front wheel tray and a rear wheel tray;
wherein the front wheel tray is taller than the rear wheel tray to hold a front wheel of the bicycle in an upright fixed position to aid a user during mounting of the bicycle to the bicycle rack; and
wherein at least one of the front wheel tray and the rear wheel tray slide to accommodate different bicycle sizes;
wherein at least one of the front wheel tray and the rear wheel tray is smaller than the other wheel tray to eliminate fore and aft movement, and to accommodate different sizes of bicycle.

5. The bicycle rack of claim 1, wherein the stabilizer has an artistic design element.

6. The bicycle rack of claim 1, further comprising at least one down-leg positioned for mounting to a floor of the truck bed, the at least one down-leg is adjustable to accommodate different depth truck beds.

7. The bicycle rack of claim 6, wherein the at least one down-leg is formed by a slotted channel with a flat bar drilled to accept a nut and bolt, wherein the flat bar fits into the slotted channel.

8. The bicycle rack of claim 7, wherein the at least one down-leg has openings formed in the channel and bolt holes in the flat bar to adjust a height of the down-legs.

9. A bicycle rack for a bicycle having two wheels and a bicycle frame, comprising:
a base for securely attaching to a hitch receiver of a truck or other vehicle;
a wheel mounting assembly for receiving the two wheels of the bicycle; and
at least one wheel stabilizer connected to the base; and
wherein the two wheels of the bicycle are positioned in the wheel mounting assembly to mount the bicycle to the hitch receiver of the truck;
wherein the wheel stabilizer reduces or altogether eliminates sway of the bicycle during transport.

10. The bicycle rack of claim 9, wherein the wheel mounting assembly has a front wheel slot and a rear wheel slot.

11. The bicycle rack of claim 10, wherein both the front wheel slot and the rear wheel slot slide to different positions within the base to accommodate different bicycle sizes.

12. The bicycle rack of claim 10, wherein the front wheel slot is smaller than the rear wheel slot.

13. The bicycle rack of claim 10, wherein at least one of the front wheel slot and the rear wheel slot comprises opposing wedge tire stops, the wedge tire stops receiving the a tire of the bicycle therebetween to limit sway of the bicycle.

14. The bicycle rack of claim 13, wherein one of the opposing wedge tire stops is fixedly mounted to the base, and another of the opposing wedge tire stops is adjustable.

15. The bicycle rack of claim 9, wherein the at least one wheel stabilizer comprises a front wheel arm rotatable between an open position for mounting the bicycle in the wheel mounting assembly, and a closed position for securing to at least one of the wheels of the bicycle.

16. The bicycle rack of claim 15, wherein the at least one wheel stabilizer comprises both a front wheel arm and a rear wheel arm.

17. The bicycle rack of claim 16, wherein the front wheel arm and a rear wheel arm have slots that fit at least partially around a front wheel and a back wheel of the bicycle to hold the bicycle in an upright position.

18. The bicycle rack of claim 9, wherein the base is slotted to receive the two wheels of the bicycle.

19. A bicycle rack for a bicycle having two wheels and a bicycle frame, comprising:
a base having at least one slot for receiving the two wheels of the bicycle, the base for securely attaching to a hitch receiver of a truck or other vehicle;
a size adjustable wheel mounting assembly of the base, the wheel mounting assembly having a first front wedge tire stop and a first rear wedge tire stop for receiving the first of the two wheels of the bicycle, and the wheel mounting assembly having a second front wedge tire stop and a second rear wedge tire stop for receiving the second of the two wheels of the bicycle; and
a front wheel stabilizer rotatably connected to a first side the base for attachment to the first of the two wheels of the bicycle, the front wheel stabilizer having a first upper wedge tire stop and a first lower wedge tire stop for securing the first of the two wheels of the bicycle therebetween;
a rear wheel stabilizer rotatably connected to a second side of the base for attachment to the second of the two wheels of the bicycle, the rear wheel stabilizer having a second upper wedge tire stop and a second lower wedge tire stop for securing the second of the two wheels of the bicycle therebetween; and
wherein the two wheels of the bicycle are positioned in the wheel mounting assembly of the base to mount the bicycle to the base mounted to the hitch receiver of the truck;
wherein the wheel stabilizer reduces or altogether eliminates sway of the bicycle during transport.

20. The bicycle rack of claim 19, wherein the front wheel stabilizer and the rear wheel stabilizer are rotatable between an open position for mounting and dismounting the bicycle, and a closed position for securing the wheels of the bicycle for transport.
